(19) United States
(12) Patent Application Publication
(10) Pub. No.: US 2012/0005494 A1
(43) Pub. Date: Jan. 5, 2012

(54) HOST COMPUTER AND METHOD FOR STARTING HARD DISKS

(75) Inventor: JIAN PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/159,366

(22) Filed: Jun. 13, 2011

(30) Foreign Application Priority Data
Jul. 2, 2010 (CN) 201010216517.6

(51) Int. Cl. G06F 1/26

(52) U.S. Cl. 713/300

(57) ABSTRACT

A method for starting hard disks connected to a host computer. The host computer comprises a power port. A general purpose input/output (GPIO) signal of each of the hard disks is set to a low level. The method detects a hard disk with a low level GPIO signal. The GPIO signal of the hard disk is then pulled up from a low level to a high level. After a preset time delay, the method continuously detects the hard disk with a low level GPIO signal until the GPIO signal of each of the hard disks is at a high level.

### BACKGROUND

1. Technical Field

Embodiments of the present disclosure generally relate to hard disk management, and more particularly to a method and system for starting hard disks connected to a host computer.

2. Description of Related Art

A computer may be installed with one or more hard disks. Usually, starting a hard disk takes about 2.5 amperes of current. After the hard disk is started, current consumed by the hard disk is about 0.5 amperes. If all hard disks of the computer are started at the same time, the current consumed by starting the hard disks may be too high, which may cause a breakdown of the power supply of the computer.

### BRIEF DESCRIPTION OF THE DRAWINGS

FIG. 1 is a block diagram of one embodiment of a host computer including a management system.

FIG. 2 is a block diagram of one embodiment of function modules of the management system of FIG. 1.

FIG. 3 is a flowchart of one embodiment of a method for starting hard disks connected to the host computer of FIG. 1.

### DETAILED DESCRIPTION

The application is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

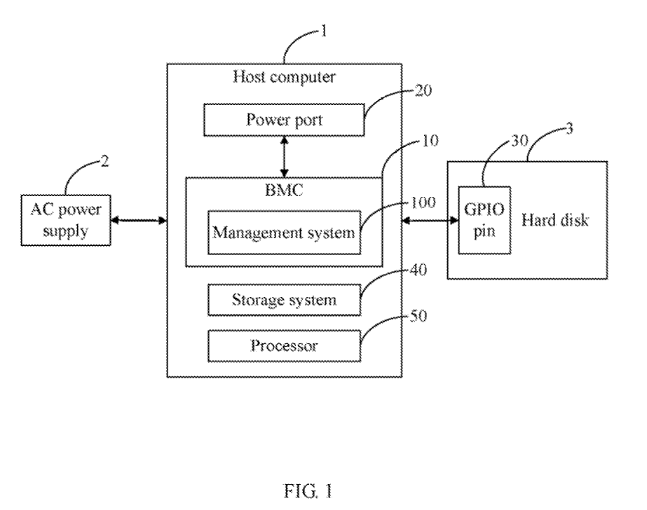

FIG. 1 is a block diagram of one embodiment of a host computer 1 including a management system 100. In one embodiment, the host computer 1 includes a baseboard management controller (BMC) 10 and a power port 20. The host computer 1 may be a type of server, for example. The host computer 1 is electrically connected to an alternating current (AC) power supply 2 and one or more hard disks 3. Each hard disk 3 includes a general purpose input/output (GPIO) pin 30.

The power port 20 electrically connected to the BMC 10 is a power GPIO port of the host computer 1. A GPIO signal from the power port 20 may indicate to the management system 100 the power status of the host computer 1. In some embodiments, if the GPIO signal from the power port 20 is high level, such as a “1”, the host computer 1 is in a power-on status. If the GPIO signal from the power port 20 is low level, such as a “0”, the host computer 1 is in a power-off status.

A GPIO signal of the hard disk 3 may be a start signal for the hard disk 3, transmitted from the management system 100 to the GPIO pin 30. In some embodiments, if the GPIO signal of the hard disk 3 is high level, such as a “1”, the hard disk 3 has been started. If the GPIO signal of the hard disk 3 is low level, such as a “0”, the hard disk 3 has not been started.

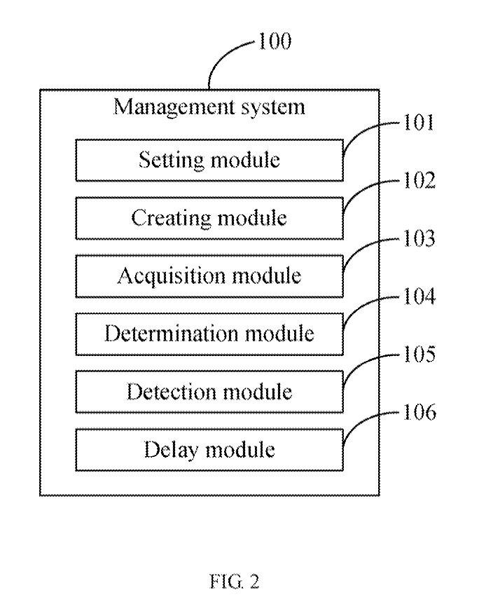

In one embodiment, the management system 100 may include one or more function modules (detailed description is given in FIG. 2). The one or more function modules may comprise computerized code in the form of one or more programs that are stored in a storage system 40, and executed by a processor 50 of the host computer 1 to provide the above-mentioned functions of the management system 100. Depending on the embodiment, the storage system 40 may be a memory system within the host computer 1.

FIG. 2 is a block diagram of one embodiment of function modules of the management system 100 of FIG. 1. In one embodiment, the management system 100 includes a setting module 101, a creating module 102, an acquisition module 103, a determination module 104, a detection module 105 and a delay module 106.

The setting module 101 is operable to set a GPIO signal of each hard disk 3 to a low level, such as “0”.

The creating module 102 is operable to create a task for detecting a GPIO signal from the power port 20.

The acquisition module 103 is operable to periodically acquire the GPIO signal from the power port 20. For example, the acquisition module 103 may acquire the GPIO signal from the power port 20 once every second.

The determination module 104 is operable to determine the power-on or power-off status of the host computer 1 according to the GPIO signal from the power port 20. In some embodiments, if the GPIO signal from the power port 20 is a “1”, the determination module 104 determines that the host computer 1 is in a power-off status. If the GPIO signal from the power port 20 is a “0”, the determination module 104 determines that the host computer 1 is in a power-on status.

The detection module 105 is operable to detect a hard disk 3 with a low level GPIO signal, upon the condition that the host computer 1 is in the power-on status.

The setting module 101 further operable to pull up the GPIO signal of the hard disk 3 from a low level to a high level, upon the condition that a hard disk 3 with a low level GPIO signal is detected. In some embodiments, if there are more than one hard disk 3 with a low level GPIO signal, the setting module 101 selects one of the hard disks 3, and pulls up the GPIO signal of the selected hard disk 3 from a low level to a high level to start it.

The delay module 106 is operable to impose a preset time delay (e.g., for 0.5 seconds) after the hard disk 3 is started.

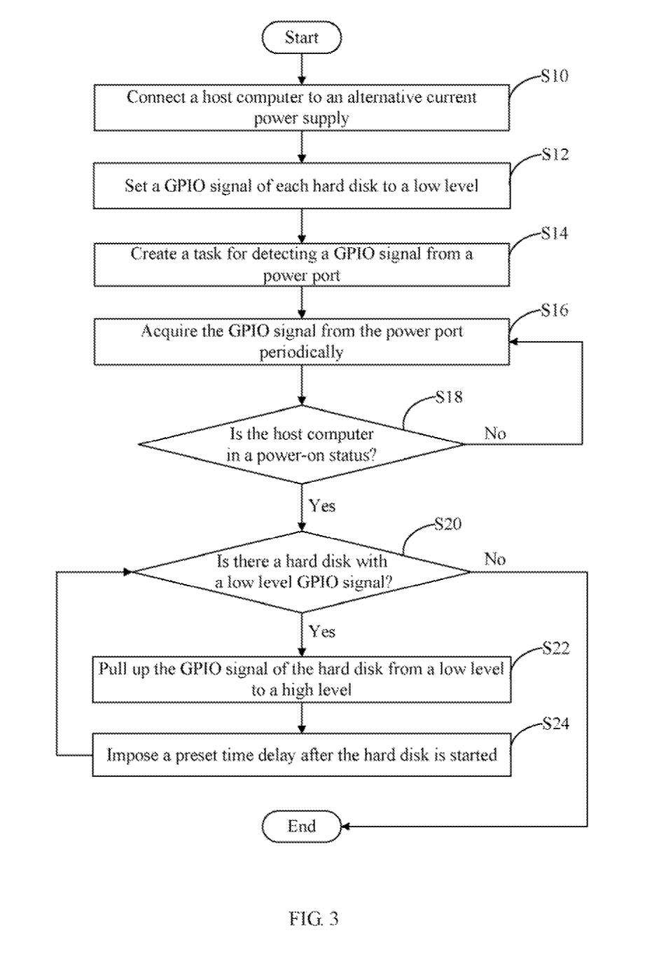

FIG. 3 is a flowchart of one embodiment of a method for starting hard disks connected to the host computer 1 of FIG. 1. Depending on the embodiment, additional blocks may be added, others removed, and the ordering of the blocks may be changed.

In block S10, the host computer 1 is connected to an AC power supply 2.

In block S12, the setting module 101 sets a GPIO signal of each hard disk 3 to a low level, such as “0”.

In block S14, the creating module 102 creates a task for detecting a GPIO signal from the power port 20.

In block S16, the acquisition module 103 periodically acquires the GPIO signal from the power port 20. For example, the acquisition module 103 may acquire the GPIO signal from the power port 20 once every second.

In block S18, the determination module 104 determines the power-on or power-off status of the host computer 1 according to the GPIO signal from the power port 20. In some embodiments, if the GPIO signal from the power port 20 is a “1”, the determination module 104 determines that the host computer 1 is in a power-off status. If the GPIO signal from the power port 20 is a “0”, the determination module 104 determines that the host computer 1 is in a power-on status. If the host computer 1 is in the power-off status, the procedure will go to block S16.

If the host computer 1 is in the power-on status, in block S20, the detection module 105 detects a hard disk 3 with a low level GPIO signal. If a hard disk 3 with a low level GPIO signal is not detected, the procedure is ended.

If a hard disk 3 with a low level GPIO signal is detected, in block S22, the setting module 101 pulls up the GPIO signal of the hard disk 3 from a low level to a high level. In some embodiments, if there are more than one hard disk 3 with a low level GPIO signal, the setting module 101 selects one of the hard disks 3, and pulls up the GPIO signal of the selected hard disk 3 from a low level to a high level to start it.

In block S24, the delay module 106 imposes a preset time delay (e.g., for 0.5 seconds) after the hard disk 3 is started, and the procedure will go to block S20 until the GPIO signal of each hard disk 3 is at a high level.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. A method for starting hard disks connected to a host computer, the host computer comprising a power port, the method comprising:
(a) setting a general purpose input/output (GPIO) signal of each of the hard disks to a low level;
(b) detecting a hard disk with a low level GPIO signal;
(c) pulling up the GPIO signal of the hard disk from a low level to a high level; and
(d) imposing a preset time delay after the hard disk is started, and returning to block (b) until the GPIO signal of each of the hard disks is at a high level.

2. The method as claimed in claim 1, between block (a) and block (b) further comprising:
creating a task for detecting a GPIO signal from the power port;
acquiring the GPIO signal from the power port periodically;
determining the power-on or power-off status of the host computer according to the GPIO signal from the power port;
executing block (b) upon the condition that the host computer is in the power-on status; and
returning to the acquiring block upon the condition that the host computer is in the power-off status.

3. The method as claimed in claim 1, before block (a) further comprising:
connecting the host computer to an alternative current (AC) power supply.

4. The method as claimed in claim 1, wherein the low level is logic 0 and high level is logic 1.

5. A storage medium storing a set of instructions, the set of instructions capable of being executed by a processor to perform a method for starting hard disks connected to a host computer, the host computer comprising a power port, the method comprising:
(a) setting a general purpose input/output (GPIO) signal of each of the hard disks to a low level;
(b) detecting a hard disk with a low level GPIO signal;
(c) pulling up the GPIO signal of the hard disk from a low level to a high level; and
(d) imposing a preset time delay after the hard disk is started, and returning to block (b) until the GPIO signal of each of the hard disks is at a high level.

6. The storage medium as claimed in claim 5, wherein between block (a) and block (b), the method further comprising:
creating a task for detecting a GPIO signal from the power port;
acquiring the GPIO signal from the power port periodically;
determining the power-on or power-off status of the host computer, according to the GPIO signal from the power port;
executing block (b) upon the condition that the host computer is in the power-on status;
and returning to the acquiring block upon the condition that the host computer is in the power-off status.

7. The storage medium as claimed in claim 5, wherein before block (a), the method further comprising:
connecting the host computer to an alternative current (AC) power supply.

8. The storage medium as claimed in claim 5, wherein the low level is logic 0 and high level is logic 1.

9. A host computer, the host computer being connected to one or more hard disks, the host computer comprising:
a storage system;
a power port;
at least one processor; and
one or more programs stored in the storage system, executable by the at least one processor, the one or more programs comprising:
a setting module operable to set a general purpose input/output (GPIO) signal of each of the hard disks to a low level;
a detection module operable to detect a hard disk with a low level GPIO signal;
the setting module further operable to pull up the GPIO signal of the hard disk from a low level to a high level; and
a delay module operable to impose a preset time delay after the hard disk is started.

10. The host computer as claimed in claim 9, wherein the one or more programs further comprise:
a creating module operable to create a task for detecting a GPIO signal from the power port;
an acquisition module operable to acquire the GPIO signal from the power port periodically; and
a determination module operable to determine the power-on or power-off status of the host computer according to the GPIO signal from the power port.

11. The host computer as claimed in claim 9, wherein the host computer is connected to an alternative current (AC) power supply.

12. The host computer as claimed in claim 9, wherein the low level is logic 0 and high level is logic 1.
